(19) United States
(12) Patent Application Publication
(10) Pub. No.: US 2008/0101478 A1
(43) Pub. Date: May 1, 2008

(54) Decoding device and decoding method

(75) Inventor: Makoto Kusunoki, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/976,405

(22) Filed: Oct. 24, 2007

(30) Foreign Application Priority Data
Oct. 31, 2006 (JP) 2006-297146

(51) Int. Cl. H04N 7/26

(52) U.S. Cl. 375/240.28; 375/E07.189

(57) ABSTRACT

According to one embodiment, a video PTS correction unit judges whether or not a PTS written in a PES header of a video PES contained in a video PES buffer is at an abnormal value, corrects the PTS if it is abnormal value, and adds the PTS to each video frame of the video PES. A video frame separator unit separates a video frame to which the PTS was added, from the video PES. A video decoder decodes the separated video frame and provides the decoded video frame at a time set based on the PTS of the video frame.

### CROSS-REFERENCE TO RELATED APPLICATIONS

This application is based upon and claims the benefit of priority from Japanese Patent Application No. 2006-297146, filed Oct. 31, 2006, the entire contents of which are incorporated herein by reference.

### BACKGROUND

1. Field

One embodiment of the present invention relates to a decoding device which receives an encoded stream transmitted by digital broadcasting and decodes the encoded stream, as well as to such a decoding method.

2. Description of the Related Art

In the digital broadcasting, the video encoding mode is defined by ARIB STD-B32, and video PES encoded in MPEG2 format includes a frame of video data. In the header of the video PES, time data called PTS is written. Image data decoded by an image decoder are output to a monitor device at a timing indicated by PTS, and thus video and audio are synchronized. With this configuration, when PTS is at an abnormal value, the video data cannot be normally decoded and reproduced. Jpn. Pat. Appln. KOKAI Publication No. 2003-284066 (FIG. 3) discloses a decoding device which can output data at a timing intended by a decoder even when PTS contained in encoded data is abnormal.

In the mobile broadcasting or one-segment broadcasting, H.264 (MPEG4-AVC) is employed as the video encoding format. H.264 has a higher compression performance than that of MPEG 2, but in order to increase the compression efficiency for the case where data are compressed into PES, it is permitted to insert two or more video frames to one video PES. Here, in the conventional case, a value described in the video PES is used as PTS of each frame to be output to the monitor device in every case. By contrast, in the case of a PES containing two or more frames, PTS need to be calculated for each frame in the PES from the PTS value of the header of the PES and the frame rate.

In Jpn. Pat. Appln. KOKAI Publication No. 2003-284066 mentioned above, the video frame interval is fixed to 33 msec and on the presumption of that the packetized elementary streams (PES) arrive at equal intervals, whether or not a PTS value is abnormal is judged based on the arrival time of PES, and abnormal PTS is corrected. However, PESs, each containing two or more frames, do not always arrive at equal intervals, and therefore the conventional technique entails such a drawback that PTS cannot be appropriately corrected.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing the configuration of an MPEG2-TS (transport stream);

FIG. 2 is a diagram showing the configuration of a TS header;

FIG. 3 is a diagram showing the configuration of a PES;

FIG. 4 is a diagram showing the configuration of a PES containing a single frame;

FIG. 5 is a diagram showing the configuration of a PES containing two or more frames;

FIG. 6 is a diagram showing the configuration of an access unit in which intra-frame encoding is carried out, which is called IDR picture;

FIG. 7 is a diagram showing the configuration of an access unit called non-IDR picture, in which inter-frame encoding is carried out;

FIG. 8 is a block diagram showing the configuration of a digital broadcasting receiving device as a decoding device according to an embodiment of the present invention;

FIGS. 9A to 9D are explanatory diagrams illustrating a process carried out onto a PES containing two or more frames of H.264 format;

FIGS. 10A to 10C are explanatory diagrams illustrating a method of correcting PTS of a PES containing two or more frames;

FIGS. 11A and 11B are flowcharts illustrating the operation of a video PTS correction unit in detail; and

FIGS. 12A to 12C are diagrams illustrating the cases where errors occur in AU delimiters.

### DETAILED DESCRIPTION

Various embodiments according to the invention will be described hereinafter with reference to the accompanying drawings. In general, according to one embodiment of the invention, there is provided a decoding device comprising: a receiver unit which provides a TS including a PES comprising one or more frames upon reception of broadcast wave; a first separator unit which extracts the PES from the TS provided from the receiver unit and separates the PES into a video PES and an audio PES; a correction unit which judges whether or not a PTS written in a PES header of the video PES separated by the first separator unit is at an abnormal value, and if it is an abnormal value, corrects the abnormal PTS value, whereas if it is a normal value, maintains the normal value as it is; an adder unit which adds a PTS to each of the two or more video frames of the video PES processed by the correction unit; a second separator unit which separates a video frame to which the PTS was added, from the video PES processed by the adder unit; and a decoding unit which decodes the video frame separated by the second separator unit and provides the decoded video frame at a time set based on the PTS of the video frame.

With the above-described structure, if the PTS of a PES comprising two or more video frames takes an abnormal value, it will be corrected to a normal value. Therefore, the normal PTS value is added to each video frame contained in the PES, and thus the image can be output without interruptions.

Before describing the digital broadcast receiving device according to the present invention, each of the streams processed by the digital broadcast receiving device will now be described.

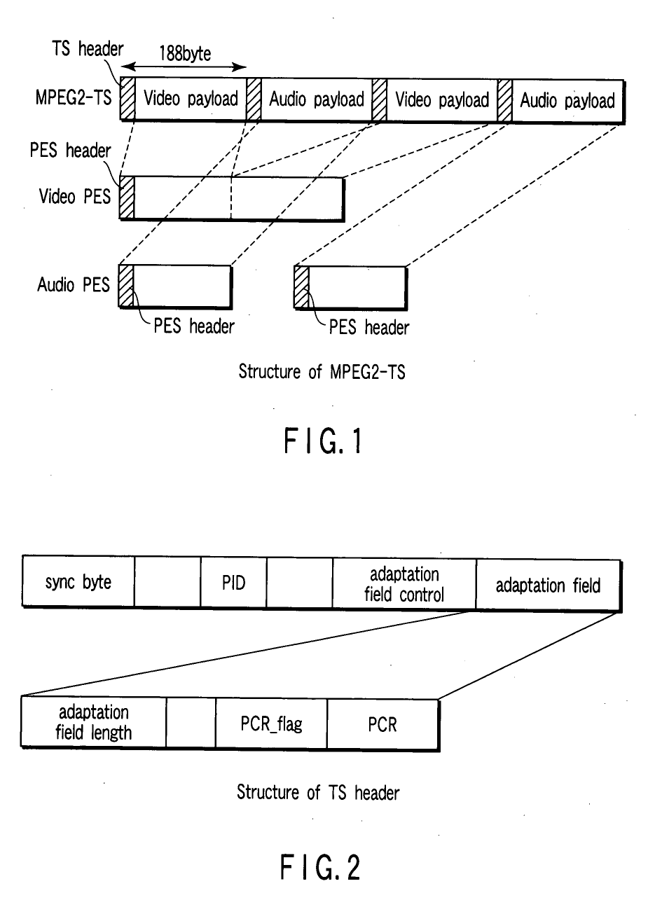

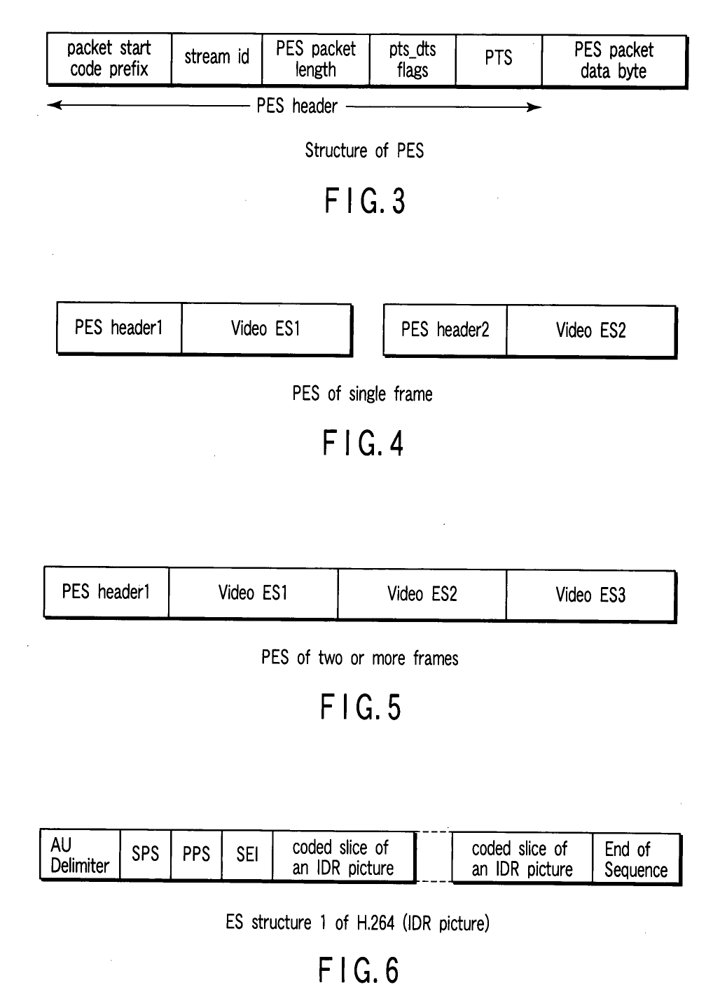

FIG. 1 shows the structure of an MPEG2-transport stream (TS). The MPEG2-TS comprises a packet row and one packet has 188 bytes. Each packet comprises a header portion and a payload portion. The payload portion stores separated video PES and audio PES. FIG. 2 shows the structure of the TS header. PID is called a packet ID, and the video PES and audio PES respectively have uniquely determined PID values which are different from each other. FIG. 3 shows the structure of the PES. A PES comprises a header portion called PES header and a main body of an elementary stream (ES) called PES packet data byte. The ES comprises video or audio data themselves which have been compressed and encoded. To the PES header, a presentation time stamp (PTS) is put, which indicates the time to display the ES located at the leading portion of the PES packet data byte.

FIG. 4 shows a PES comprising a single frame.

A PTS contained in a PES header 1 indicates the time to output a decoded video ES1, and a PTS put to a PES header 2 indicates the time to output a decoded video ES2. FIG. 5 shows a PES comprising two or more frames (in this case, three frames). A PTS contained in a PES header 1 shown in FIG. 5 indicates the time to output a decoded video ES1.

Next, the ES structure of H.264 will now be described. In H.264, a unit of ES which constitutes one picture is called access unit. FIG. 6 shows the structure of an access unit in which intra-frame encoding is carried out, which is called IDR (instantaneous decoding refresh) picture. IDR picture is equivalent to I picture in MPEG2 format, and decoding can be performed solely by IDR picture. AU delimiter indicates the head of an access unit. A sequence parameter set (SPS) contains data relating to encoding of the entire sequence written therein. A picture parameter set (PPS) contains data indicating an encoding mode of the entire sequence written therein. A supplemental enhancement information (SEI) contains data such as frame rate written therein. A coded slice of an IDR picture is a part of image data which form the IDR picture, and one frame comprises one or more coded slice of an IDR picture. An end of sequence indicates the end of the access unit.

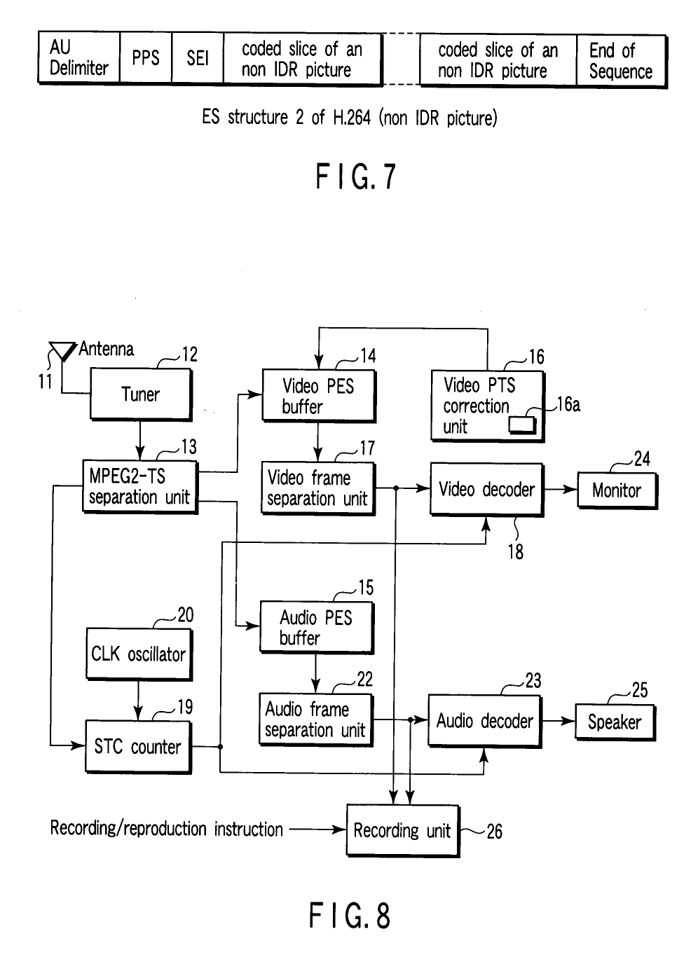

FIG. 7 shows the structure of an access unit in which inter-frame encoding is carried out, which is called non IDR picture. Non IDR picture is equivalent to P picture, B picture or the like, in the MPEG2 format, and it is not able to perform decoding by itself but able to perform decoding by using the data of other picture. The AU delimiter, PPS, SEI and end of sequence have the same contents as those of IDR picture. The coded slice of an non IDR picture is a part of the image data which constitute a non IDR picture, and one frame comprises one or more coded slice of an non IDR picture.

Next, the digital broadcasting receiving device of the present invention will now be described.

FIG. 8 is a block diagram showing the structure of the digital broadcasting receiving device as a decoding device according to an embodiment of the present invention.

Broadcast wave input through an antenna 11 is demodulated into MPEG2-TS by a tuber 12. Then, MPEG2-TS is separated into video PES and audio PES, which are respectively stored in a video PES buffer 14 and an audio PES buffer 15. During this period, a video PTS correction unit 16 judges whether or not PTS written in each PES header is at an normal value, and if it is judged to be abnormal, corrects the PTS. When the video PES comprises two or more frames, a PTS adder unit 16a calculates PTS of each of the frames other than the header frame based on a frame rate, and add the calculated PTS to the respective frame. The frame rate is written in SEI of IDR picture. (See FIGS. 6 and 7.) In the meantime, the video PTS correction unit 16 compares PTS of each video frame to PTSs of the one preceding and succeeding frames, and if a PTS abnormal value is detected, corrects the PTS. Video PES processed by the video PTS correction unit 16 is supplied to a video frame separating unit 17.

The video frame separating unit 17 separates (extracts) PTS and video ES from video PES, and it supplies video ES for each frame and its corresponding PTS to a video decoder 18.

An STC counter 19 counts system time clock (STC), which is a clock signal generated by a clock generator 20, and it supplies the count value to the video decoder 18 and an audio decoder 23. Here, MPEG2-TS separating unit 13, at the time of start, sets the output value of an STC counter 19 to an appropriate value based on input data. The STC counter 19 starts counting from the set value.

The video decoder 18 decodes each video ES from the video frame separation unit 17. Then, the decoder compares the PTS added to each video ES and the value on the STC counter 19 with each other, and outputs the decoded video image to a monitor device 24, for example, at a timing where they coincide with each other. A recording unit 26 comprises a DVD drive, HDD or the like. This unit records video ES from the video frame separation unit 17 and audio ES from the audio frame separation unit 22 in accordance with a recording instruction, and reproduces the recorded video ES and audio ES in accordance with the reproduction instruction.

The operations of an audio PES buffer 15, an audio frame separation unit 22 and an audio decoder 23 are similar to those of the video PES buffer 14, video frame separation unit 17 and video decoder 28, respectively, and therefore the detailed descriptions thereof will be omitted here.

Embodiments of the process carried out on PES containing two or more frames will now be described.

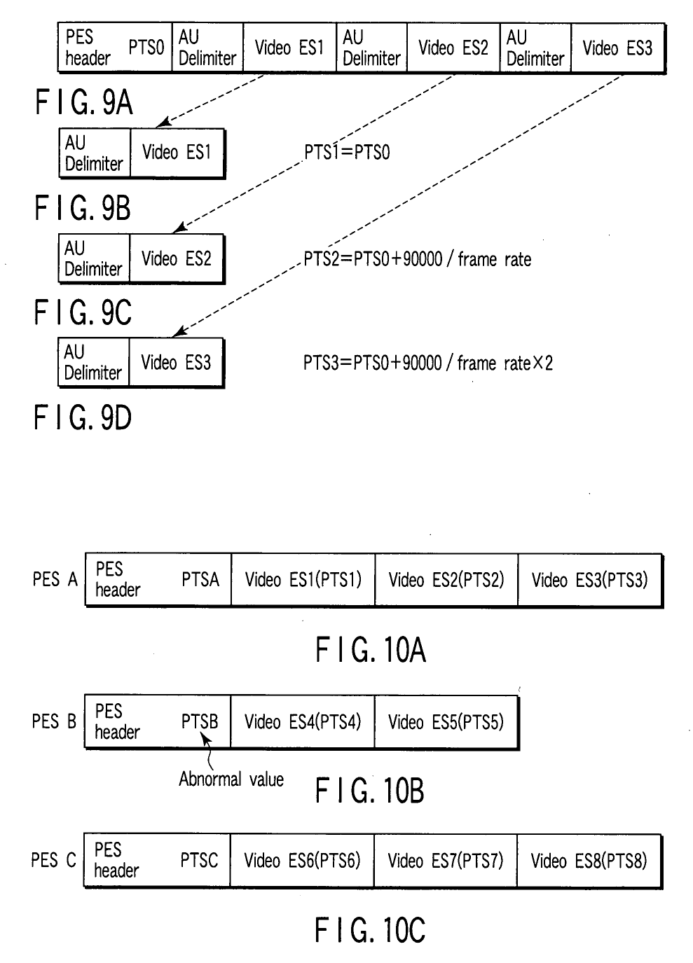

FIGS. 9A to 9D are explanatory diagrams illustrating a process carried out onto a PES containing two or more frames of H.264 format, and the explanation will be provided for an example case where 1 PES contains 3 frames.

FIG. 9A shows a PES stored in the video PES buffer 14 from the MPEG2-TS separation unit 13. One video ES is defined from the position of an AU delimiter to the next AU delimiter, which contain the data for one frame. In this example, the time data PTS in the PES header is set as PTS0, and no error occurs in the values of the PTS0 and each AU delimiter.

FIGS. 9B to 9D shows how PTS is added to each video ES. PTS is a value determined based on the value of the counter operating at 90 kHz. Therefore, where PTS of the video ES1 is defined as PTS1, PTS of the video ES2 is defined as PTS2 and PTS of the video ES3 is defined as PTS3, the following equations are established.
PTS1=PTS0
PTS2=PTS+90000/frame rate
PTS3=PTS0+(90000/frame rate)×2

For example, when the frame rate is 15 frames/sec., PTS2 is PTS0+6000, and PTS3 is PTS0+12000. When the frame rate is constant, the PTS difference between adjacent frames is at a constant value (9000/frame rate) in accordance with the frame rate.

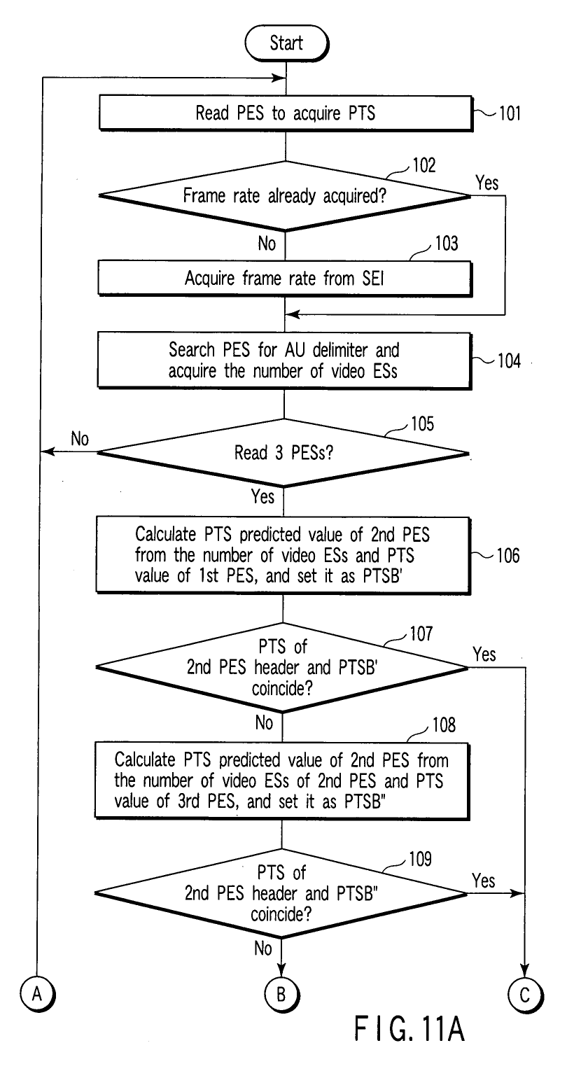

Next, the method of correcting PTS of PES containing two or more video frames will now be described with reference to FIG. 10. This example includes such a case where PTS in the PES header is at an abnormal value (error).

PES A shown in FIG. 10A, PES B shown in FIG. 10B and PES C shown in FIG. 10C are successive PESs, and let us suppose here that PTSA attached to the header of PES A is at a normal value, PTSB attached to the header of PES B is at an abnormal value, and PTSC attached to the header of PES C is at a normal value. PTSs of the video frames of PES A, PES B and PES C before correction will be as follows.
PTS1=PTSA
PTS2=PTSA+90000/frame rate
PTS3=PTSA+(90000/frame rate)×2
PTS4=PTSB(abnormal value)
PTS5=PTSB+90000/frame rate
PTS6=PTSC
PTS7=PTSC+90000/frame rate
PTS8=PTSC+(90000/frame rate)×2

In the conventional digital broadcasting receiving device, when PTSB is an abnormal value, the difference between PTS3 and PTS4 becomes abnormal, and an abnormal value is set to each of PTS$ and PTS5. As a result, video ES4 of PTS4 and video ES5 of PTS5 will not be output but abandoned since the value of STC does not coincide with PTS even if they are decoded by the decoder.

Next, the outline of the video PTS correction method of the video PTS correction unit 16 of the present invention will now be described with reference to FIGS. 10A to 10C.

First, the video PTS correction unit 16 checks how many video frames are contained in PES A. The number of video frames in PES A (that is, the number of AU delimiter) is 3, and therefore the predicted PTS (PTSB′) of PES B is as follows:
PTSB′=PTSA+90000/frame rate×3

Next, the video PTS correction unit 16 checks how many video frames are contained in PES B. The number of video frames in PES B is 2, and therefore the predicted PTS (PTSB″) of PES B predicted from PTSC attached to PES C is as follows:
PTSB″=PTSC−90000/frame rate×2

When PTSB′=PTSB″, it can be judged that the predicted value PTSB′ is at a normal value. In FIGS. 10A to 10C, PTSB≠PTSB′, and thus the video PTS correction unit 16 judges that PTSB is at an abnormal value, and corrects PTSB to PTSB′. Here, PTS4 and PTS5 of PES B are as follow:
PTS4=PTSB′
PTS5=PTSB′+90000/frame rate

The video PES whose PTS has been corrected is input to the video frame separation unit 17 and then sent to a video decoder.

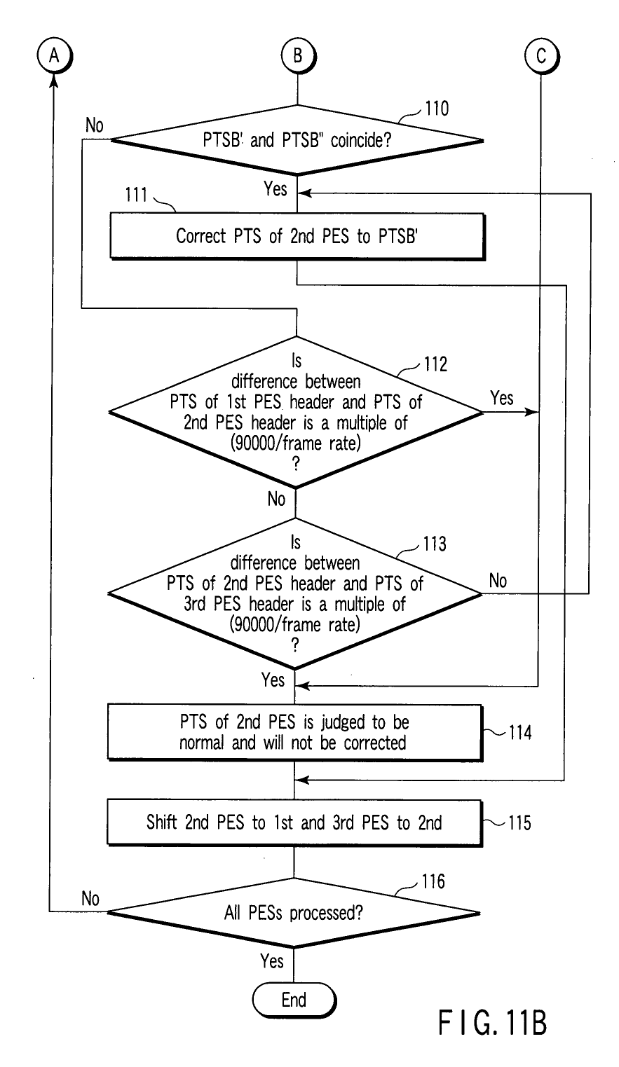

FIGS. 11A and 11B are flowcharts illustrating the operation of the video PTS correction unit 16 in detail. Assuming that PTS of the first PES header is correct, PTS contained in the PES header of the middle PES (second one) of successive 3 is processed (that is, corrected if it is an abnormal value).

First, the PTS correction unit 16 obtains PTS of the PES header while reading PESs into the video PES buffer 14 (Block 101). If the frame rate has not been obtained (No in Block 102), the frame rate is acquired from SEI (Block 103). Next, the number of AU delimiters in PES is detected and the number of video ESs is judged (Block 104). Here, the number of video ESs (=the number of frames) is equal to the number of AU delimiters.

The correction unit 16 starts the correction process after reading 3 PESs (Yes in Block 105). When PTS of the second PES header and PTSB′ coincide with each other, it is judged that the PTS is at a normal value. When they do not coincide, the PTS predicted value of the second PES (PES B) is calculated from the number of ESs of the second PES and the PTS value (PTSC) of the third PES (PES C), and the calculated result is set as PTSB″ (Block 108).

When PTS of the second PES header and the predicted value PTSB″ coincide with each other (Yes in Block 109), the correction unit 16 judges that the PTS of the second PES header is at a normal value (Block 114). When they do not coincide (No in Block 109), it is checked whether or not the predicted values PTSB′ and PTSB″ coincide with each other. When they coincide with each other (Yes in Block 110), PTSB′ (=PTSB″) is judged to be a normal value and PTS of the second PES (PES B) is corrected to PTSB′ (Block 111).

When PTSB′ and PTSB″ do not coincide with each other (No in Block 110), the correction unit 16 checks if the difference between the 2 PES headers is a multiple of a PTS value for one frame (=90000/frame rate) (Block 112). In the case where the difference between the PTS of the first PES header and the PTS of the second PES header is a multiple of (90000/frame rate) (Yes in Block 112), it is judged that the PTS of the second PES header is at a normal value (114). If not (No in Block 112), it is checked if the difference between the PTS of the second PES header and the PTS of the third PES header is a multiple of (90000/frame rate) (Block 113). If it is, it is judged that the PTS of the second PES header is at a normal value (114). If not (No in Block 112), it is judged that the PTS of the second PES header is at an abnormal value, and the PTS is corrected as PTSB′ (Block 111). Thus, the PTS correction process of one PES is finished.

Next, the correction unit 16 shifts the second PES to the first on the video PES buffer 14, and the third PES to the second, and reads the next PES from the MPEG2-TS separation unit 13 into the PES buffer 13 as the third PES (Block 115). Thus, the correction unit 16 carried out the PTS correction process for all PESs by updating PES to be corrected one by one (Block 116).

Here, it appears possible to consider another PTS correction method, that is, each PES containing two or more video frames is separated into video frames, PTS is calculated for each video frame and added to the respective frame, and then PTS is checked and corrected. However, in this case, for example, when a PTS has an abnormal value, all of the PTSs of the video frames contained in an object PES are erroneously calculated. As a result, there rises such a problem that video frames after separation will not be reproduced.

In the embodiment of the present invention, the above-described problem is resolved by performing the PTS correction before the separation of a video frame. In the one-segment broadcasting and mobile broadcasting, video PESs each containing two or more video frames are used. With employment of the PTS correction of this embodiment, it is possible in the one-segment broadcasting receiver terminal or mobile broadcasting receiver terminal to lessen disturbance in synchronism between video and audio signals, and interruptions of video output when the video PTS becomes an abnormal value.

The above-described PTS correction method is based on the precondition that the number of video ESs contained in PES can be correctly obtained. However, there are some possible cases where an error occurs in the AU delimiter, and as a result, the number of video ESs in PES cannot be correctly acquired. As a solution to this, the fact that the differential value between PTSs written in PESs is always a multiple of the difference for one frame (=90000/frame rate) is utilized for the judgment as to whether correction is needed.

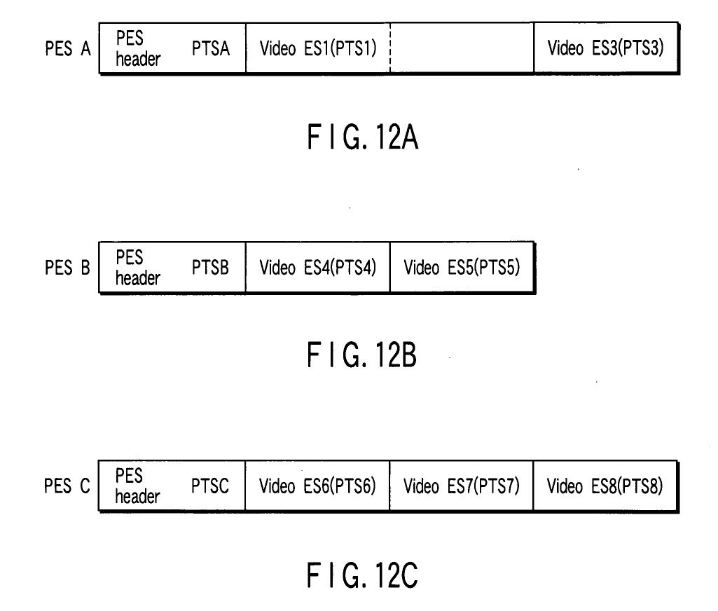

FIGS. 12A to 12C are diagrams showing the case where an error occurs in the AU delimiter. PES A shown in FIG. 12A is a PES containing 3 frames, in which PTSA is written in the PES header, but an error occurs to the AU delimiter of the video ES2 (as indicated by a dotted line in the figure). PES B shown in FIG. 12B is a PES containing 2 frames, in which PTSB is written in the PES header. PES C shown in FIG. 12C is a PES containing 3 frames, in which PTSC is written in the PES header.

The PTS correction unit 16 calculates PTS predicted value PTSB′ from PES A and PES B in the following manner. Here, an error occurred in the AU delimiter, and therefore the PTS correction unit 16 cannot detect one AU delimiter. As a result, it judges the frame of PES A as 2.
PTSB′=PTSA+(90000/frame rate)×2

Next, the PTS correction unit 16 calculates PTSB″ from PES B and PES C in the following manner.
PTSB″=PTSC−(90000/frame rate)×2

In this example, PTSB≠PTSB′ and PTSB=PTSB″. Let us suppose that when the PTS takes an abnormal value, data of 33 bit (the number of bits of PTS) go wrong at random. In this case, the possibility of the PTS becoming a multiple of the PTS value (90000/frame rate) for one frame by error is extremely low. Therefore, in the above case, it can be judged that the AU delimiter (video ES) dropped out within PES A. Thus, in the case where the difference between PTSs of successive two PES headers is a multiple of the PTS value (90000/frame rate) for one frame, it is judged that these PTS values are substantially normal.

Further, in the case where there is a dropout in the AU delimiter within a PES, the number of video ESs detected is smaller than the number of actual video ESs. Therefore, the value obtained by addition of PTS for 1 frame or 2 frames should be added to the above-described predicted value candidate as a predicted value of PTS to be written in the next PES header. In this manner, a PTS abnormal value judgment that can deal with the data error of the AU delimiter can be carried out.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A decoding device comprising:
a receiver unit which provides, upon reception of broadcast wave, a TS including a PES comprising one or more frames;
a first separator unit which extracts the PES from the TS provided from the receiver unit and separates the PES into a video PES and an audio PES;
a correction unit which judges whether or not a PTS written in a PES header of the video PES separated by the first separator unit is at an abnormal value, and if it is an abnormal value, corrects the abnormal PTS value, whereas if it is a normal value, maintains the normal value as it is;
an adder unit which adds a PTS to each of the two or more video frames of the video PES processed by the correction unit;
a second separator unit which separates a video frame to which the PTS was added, from the video PES processed by the adder unit; and
a decoding unit which decodes the video frame separated by the second separator unit and provides the decoded video frame at a time set based on the PTS of the video frame.

2. The decoding device according to claim 1, wherein
the video PES is in an H.264 format, and each of the video frames contained in the video PES contains an AU delimiter, and
the correction unit determines the number of frames in the video PES based on the number of Au delimiters contained in the video PES, and corrects the abnormal PTS based on the number of frames.

3. The decoding device according to claim 2, wherein the adder unit adds the PTS to each respective video frame of the video PES based on the PTS written in each of the PES headers of adjacent video PESs and a predetermined PTS differential value corresponding to a frame rate of the video PES.

4. The decoding device according to claim 1, wherein the correction unit judges, if the difference between PTSs written in two consecutive PES headers is an multiple of a PTS value for one frame, that these PTS values are correct.

5. The decoding device according to claim 1, further comprising: a display unit that displays an image based on the image frame decoded by the decoder.

6. A decoding method comprising:
providing, upon reception of broadcast wave, a TS including a PES comprising one or more frames;
extracting the PES from the TS and separating the PES into a video PES and an audio PES;
judging whether or not a PTS written in a PES header of the video PES separated is at an abnormal value, and if it is an abnormal value, correcting the abnormal PTS value;
adding a PTS to each of the two or more video frames of the video PES in which the abnormal PTS was corrected;
separating a video frame to which the PTS was added, from the video PES; and
decoding the separated video frame and providing the decoded video frame at a time set based on the PTS of the video frame.
